(19) United States
(12) Patent Application Publication
(10) Pub. No.: US 2024/0218944 A1
(43) Pub. Date: Jul. 4, 2024

(54) MULTI-SIZED CABLE CLAMP

(71) Applicant: Hubbell Incorporated, Shelton, CT (US)

(72) Inventors: Eric Miller, West Chester, OH (US); Craig Lawson, Milford, OH (US)

(21) Appl. No.: 18/403,232

(22) Filed: Jan. 3, 2024

Related U.S. Application Data
(60) Provisional application No. 63/436,962, filed on Jan. 4, 2023.

(51) Int. Cl. F16L 3/10; G02B 6/36

(52) U.S. Cl. CPC F16L 3/105; G02B 6/3616

(57) ABSTRACT

A clamp includes a first section and a second section. The first section includes a first base portion constructed from a first material and a first bushing fixed to the first base portion and constructed from a second material that is more compressible than the first material. The first bushing includes a first groove with a first projection that can deform based on the size of the cable received within the first groove. The second section is removable connected to the first section and includes a second base portion constructed from a third material, and a second bushing fixed to the second base portion and constructed from a fourth material that is more compressible than the third material. The second bushing includes a second projection and is aligned with the first groove. The second projection can deform based on the size of the cable received within the second groove.

### CROSS-REFERENCE TO RELATED APPLICATIONS

This application claims the benefit of U.S. Provisional Application No. 63/436,962, filed Jan. 4, 2023, the entire contents of which is incorporated herein by reference in its entirety.

### FIELD

The present disclosure relates to a clamp for communication cables. More particularly, the present disclosure relates to a clamp for communication cables that is formed from a flexible material to accommodate different sized cables and a more rigid material to minimize deflection.

### BACKGROUND

Communication cables are used to transport a signal between two locations. Communication cables may include electrical cables that transport an electrical signal, or the communication cables may be optical fibers that transport a signal using light. These cables may be used in telecommunication applications, where the signal, and therefore the cables, travel long distances.

Clamps may be used to support these cables. For example, a clamp may be connected to a pole or other support and may minimize slack in the cable. The clamp may also be connected the support to guide the cables along the support (e.g., from the top to the base of the support).

One type of clamp is constructed completely of metal. This type of clamp includes two different halves that may be positioned and secured around the cable. However, only a limited amount of torque may be applied when securing the two halves around the cable because the rigidity of the metal parts may compress the cable if overtightened, which may negatively affect signal transfer. Additionally, the completely metal construction is susceptible to cause short circuits because of lightning strikes, which can negatively affect communication. Finally, the rigidity of the metal parts prevent movement in the opening that accommodates the cable, thus limiting each clamp to a single-sized cable. In other words, a single clamp is not interchangeable across different sized cables, and a worker would need to use different clamps depending on the cable size.

Another type of clamp is constructed completely from a stiff rubber to achieve some of the rigid properties of the all metal clamp. Like the all metal clamp, the all rubber clamp is generally able to accommodate only one size of cable and therefore different clamps are required when working with different sized cables.

A final type of clamp uses a metal body with rubber inserts or bushings, which may be connected to the metal body to form different sized holes to accommodate different sized cables. The individual bushings may provide limited flexibility to accommodate a small variation in cable size. However, different bushings generally must be used when changing between different sized cables. One issue is that securing the bushings to the metal body may be difficult. It may be difficult to properly install the bushings when initially securing the clamp to the cable. When workers need to open the clamp to make repairs or replacements, the unsecured bushings may fall to the ground where they are unreachable by the worker on the support.

The foregoing underscores some of the problems associated with conventional clamps for communication cables. Furthermore, the foregoing highlights the long-felt, yet unresolved need in the art for a single clamp that may be used across different sized cables.

### SUMMARY

Various examples of the present disclosure can overcome various problems of the aforementioned and other disadvantages associated with known clamps and offer new advantages as well.

According to one aspect of various examples of the present disclosure there is provided a clamp constructed from a first material permanently fixed to a second material that is more rigid than the first material.

According to another aspect of various examples of the present disclosure, there is provided a clamp that includes a first housing formed from a rigid material and a flexible material, and a second housing formed from a rigid material and a flexible material.

According to another aspect of various examples of the present disclosure, there is provided a clamp that includes a housing constructed from a metal material and at least partially overmolded with a flexible rubber material.

According to another aspect of various examples of the present disclosure, there is provided a clamp that includes a housing constructed from a metal material and a flexible rubber material is connected to the housing after being separately formed.

According to another aspect of various examples of the present disclosure, there is provided a clamp that includes a rubber portion for contacting the cable. The rubber portion includes spaced apart ridges that flex and/or compress to accommodate different sizes of cable.

According to another aspect of various examples of the present disclosure, there is provided a clamp that includes a compressible material which forms an opening for receiving a cable and fixed to a rigid material. The compressible material is able to flex and/or compress relative to the rigid material in order to change the size of the opening.

According to another aspect of various examples of the present disclosure, there is provided a clamp for securing a cable to a support includes a first section and a second section. The first section includes a first base portion constructed from a first material and a first bushing fixed to the first base portion and constructed from a second material that is more compressible than the first material. The first bushing including a first groove with at least one first projection. The at least one first projection can deform based on the size of the cable received within the first groove. The second section is removable connected to the first section and includes a second base portion constructed from a third material, and a second bushing fixed to the second base portion and constructed from a fourth material that is more compressible than the third material. The second bushing includes a second groove aligned with the first groove and has at least one second projection. The at least one second projection is configured to deform based on the size of the cable received within the second groove.

According to another aspect of various examples of the present disclosure, there is provided a clamp for securing a cable to a support. The clamp includes a first section including a first base portion constructed from a first material. The first base portion has a pair of first projections. The first section also includes a first bushing fixed to the first base portion and spaced apart from either projection of the pair of first projections. The first bushing is constructed from a second material that is more compressible than the first material. The first bushing includes a pair of spaced apart angular portions that form a groove. The pair of angular portions is configured to deform based on the size of the cable received within the first groove. A second section is removable connected to the first section. The second section includes a second base portion constructed from a third material. The second portion has a pair of second projections that engage with the pair of first projections. The second section also includes a second bushing fixed to the second base portion and constructed from a fourth material that is more compressible than the third material. The second bushing includes a second groove aligned with the first groove. The second bushing can deform based on the size of the cable received within the second groove.

According to another aspect of various examples of the present disclosure, there is provided a clamp for securing a pair of cables to a support. The clamp includes a first section with a first base portion constructed from a first material, and a first bushing fixed to the first base portion and constructed from a second material that is more compressible than the first material. The first bushing includes a first groove that is configured to deform based on the size of a first cable of the pair of cables received within the first groove. The first section also includes a second bushing fixed to the first base portion and constructed from a second material that is more compressible than the first material. The second bushing is spaced apart from the first bushing. The second bushing includes a second groove that can deform based on the size of a second cable of the pair of cables received within the second groove. The clamp also includes a second section that is removably connected to the first section. The second section includes a second base portion constructed from a third material, and a third bushing fixed to the second base portion and constructed from a fourth material that is more compressible than the third material. The third bushing includes a third groove aligned with the first groove and a fourth groove aligned with the second groove. The third groove and/or the fourth groove can deform based on the size of the pair of cables.

According to another aspect of various examples of the present disclosure, there is provided a clamp for securing a pair of cables to a support. The clamp includes a first section with a first base portion constructed from a first material. The first base portion includes a first planar surface. The first section also includes a first bushing that is removably connected to the first base portion and constructed from a second material that is more compressible than the first material. The first bushing includes a first groove. The first groove can receive a cable and the first bushing can deform based on the size of the cable. The clamp also includes a second section that is removably connected to the first section. The second section includes a second base portion that is constructed from the first material and has a second planar surface. The second section also includes a second bushing that is removable connected to the second base portion and constructed from the second material. The second bushing including a second groove aligned with the first groove. The second groove can receive the cable and the second bushing can deform based on the size of the cable.

According to another aspect of various examples of the present disclosure, there is provided a clamp for securing a pair of cables to a support. The clamp includes a first section with a first base portion constructed from a first material. The first section also includes a first bushing that is removably connected to the first base portion and constructed from a second material that is more compressible than the first material. The first bushing includes a first groove disposed on the first side and a second groove opposite to the first groove disposed on the second side. The first groove can receive a first cable and the second groove can receive a second cable. The clamp includes second section connected to the first side of the first section and includes a second base portion constructed from the first material. The second section also includes second bushing connected to the second base portion and constructed from the second material. The second bushing includes a third groove aligned with the first groove. The third groove can receive the first cable. The clamp includes third section connected to the second side of the first section and includes a third base portion constructed from the first material. The second section also includes third bushing connected to the third base portion and constructed from the second material. The second bushing includes a fourth groove aligned with the second groove. The fourth groove can receive the second cable.

The disclosure herein should become evident to a person of ordinary skill in the art given the following enabling description and drawings. The drawings are for illustration purposes only and are not drawn to scale unless otherwise indicated. The drawings are not intended to limit the scope of the invention. The following enabling disclosure is directed to one of ordinary skill in the art and presupposes that those aspects within the ability of the ordinarily skilled artisan are understood and appreciated.

### BRIEF DESCRIPTION OF THE DRAWINGS

Various aspects and advantageous features of the present disclosure will become more apparent to those of ordinary skill when described in the detailed description of preferred embodiments and reference to the accompany drawing wherein:

FIG. 1 is a perspective view of a clamp.

FIG. 2 is a front exploded view of the clamp of FIG. 1.

FIG. 3 is a rear exploded view of the clamp of FIG. 1.

FIG. 4 is a front view of the clamp of FIG. 1.

FIG. 5 is a perspective view of a first section of the clamp of FIG. 1.

FIG. 6 is a front view of the first section of FIG. 6.

FIG. 7 is a perspective view of a first bushing and a second bushing of the clamp of FIG. 1.

FIG. 8 is a side view of one of the first bushing or the second bushing of FIG. 7.

FIG. 9 is a front view of one of the first bushing or the second bushing of FIG. 7.

FIG. 10 is a perspective view of the first and second bushings of FIG. 7 connected to the first section of FIG. 5.

FIG. 11 is a front view of FIG. 10 illustrating the first and second bushings connected to the first section.

FIG. 12 is a rear view of FIG. 10 illustrating the first and second bushings connected to the first section.

FIG. 13 is a cross-sectional view of FIG. 10 illustrating the first and second bushings connected to the first section.

FIG. 14 is a perspective view of a second section of the clamp of FIG. 1.

FIG. 15 is a front view of the second section of FIG. 15.

FIG. 16 is a perspective view of the second section of FIG. 15 connected to the first section of FIG. 5.

FIG. 17 is a front view of FIG. 16, illustrating the second section connected to the first section.

FIG. 18 is an exploded view of FIG. 16, illustrating the second section disconnected from the first section.

FIG. 19 is a perspective view of an upper bushing of the clamp of FIG. 1.

FIG. 20 is a front view of the upper bushing of FIG. 19.

FIG. 21 is a perspective view of the upper bushing of FIG. 19 coupled to the second section of FIG. 14.

FIG. 22 is a cross-sectional view of FIG. 21, illustrating the upper bushing coupled to the second section.

FIG. 23 is a perspective view of an alternate example of the upper bushing of FIG. 19 coupled to the second section of FIG. 14.

FIG. 24 is a cross-sectional view of FIG. 23, illustrating the upper bushing coupled to the second section

FIGS. 25 to 27 are perspective views of the clamp of FIG. 1 being assembled around a cable having a first diameter.

FIGS. 28 to 30 are perspective views of the clamp of FIG. 1 being assembled around a cable having a second diameter.

FIG. 31 is a perspective view of a pair of clamps of FIG. 1 supporting two pairs of cables in a first orientation.

FIG. 32 is a perspective view of a pair of clamps of FIG. 1 supporting two pairs of cables in a second orientation.

FIG. 33 is a perspective view of an alternate clamp supporting two pairs of cables.

FIG. 34 is a perspective view of the clamp of FIG. 1 in use supporting a pair of cables relative to a support.

### DETAILED DESCRIPTION

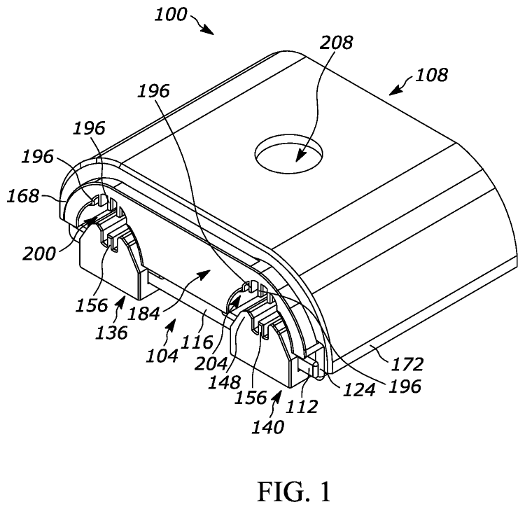

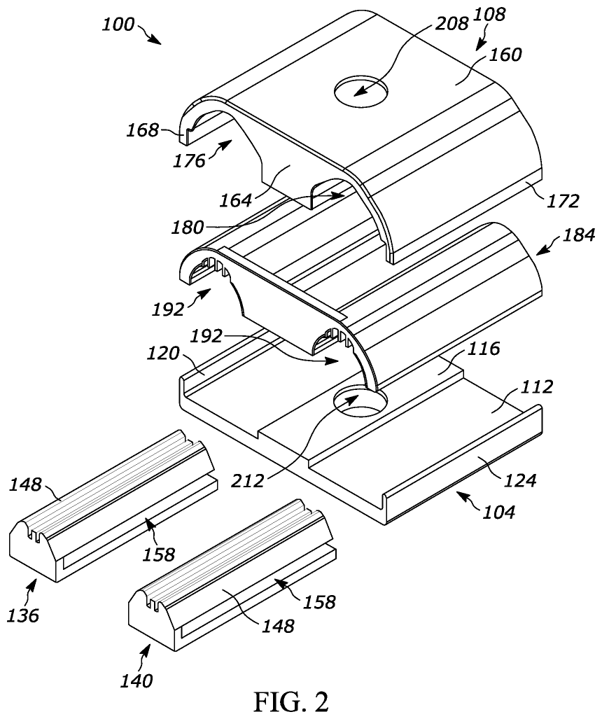

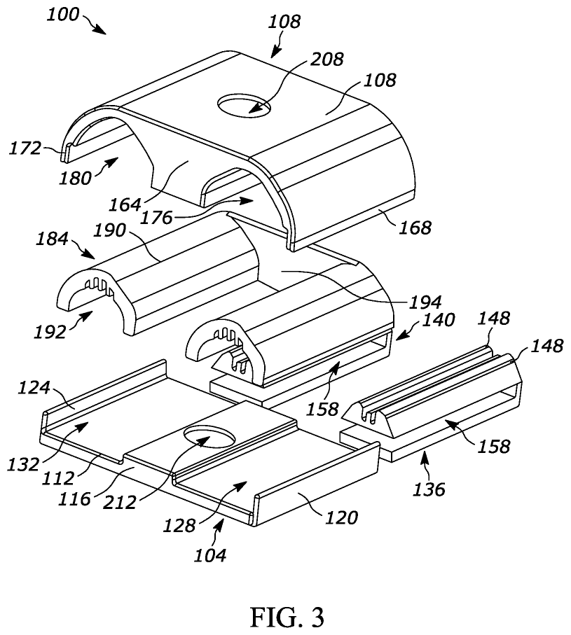

FIGS. 1 to 4 illustrate a clamp 100 that may be connected to cables. Throughout the description, the cables may be referred to as fiber optic cables, although it is contemplated that the clamp 100 may be used with any type of cable or conduit.

As shown in FIGS. 1 to 4, the clamp 100 may include a first section 104 and a second section 108. The first and second sections 104, 108 may be removably connected to support fiber optic cables.

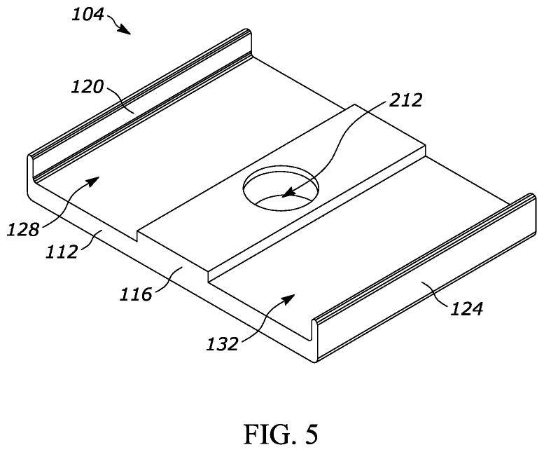

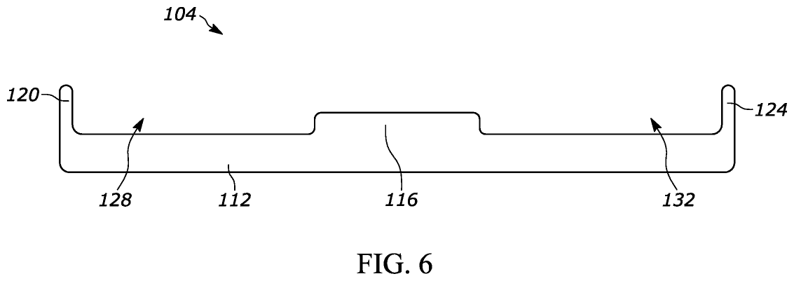

As shown in FIGS. 5 and 6, first section 104 may be formed as a generally planar structure. However, other examples of the first section 104 may include curvatures such that the first section 104 is completely planar. The first section 104 may also be formed from a rigid material to maintain the planar shape (e.g., to limit deflection). The rigid material may be a metal like aluminum, although other types of metals (e.g., steel, titanium, etc.) and/or other types of rigid materials (e.g., plastic) may be used to construct the first section 104.

The first section 104 may include a base portion 112 with a raised central portion 116. In the illustrated example, the central portion 116 may be formed approximately in the center of the base portion 112, although the central portion 116 may be offset from the center of the base portion 112. The illustrated central portion 116 is substantially perpendicular to the base portion 112, although other examples may include a central portion 116 that extends at a different angle with respect to the base portion 112.

The first section 104 may also include a projection 120, 124 on either side of the base portion 112. Each projection 120, 124 may be spaced apart from the central portion 116. In the illustrated example, each projection 120, 124 may extend substantially perpendicularly from the base portion 112. Although in other examples, the first projection 120 and/or the second projection 124 may extend from the base portion 112 at a different angle. For example, alternate examples may include the first projection 120 and/or the second projection 124 extending at an angle between about 5° and about 175°. Alternate examples may include the first projection 120 and/or the second projection 124 extending at an angle between about 25° and about 155°. Alternate examples may include the first projection 120 and/or the second projection 124 extending at an angle between about 45° and about 135°. Alternate examples may include the first projection 120 and/or the second projection 124 extending at an angle between about 65° and about 115°.

The first section 104 also may include a first compartment 128 between the central portion 116 and the first projection 120, and a second compartment 132 between the central portion 116 and the second projection 124. As shown in FIGS. 5 and 6, each compartment 128, 132 may have a generally C-shape and may extend along the length of the first section 104. The first and second compartments 128, 132 may be substantially symmetrical, although as described above, either of the compartments 128, 132 may have a different shape than the other.

In the illustrated example, the first section 104 is formed as a unitary piece where the base portion 112, the central portion 116, and the projections 120, 124 are all formed together (e.g., in a mold). However, in other examples, the central portion 116 and/or at least one of the projections 120, 124 may be formed separately from the base portion 112.

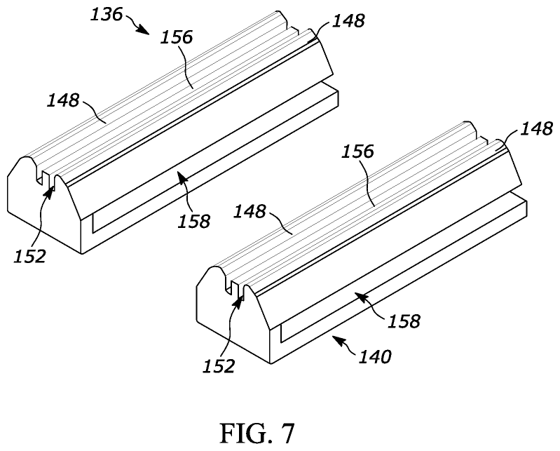

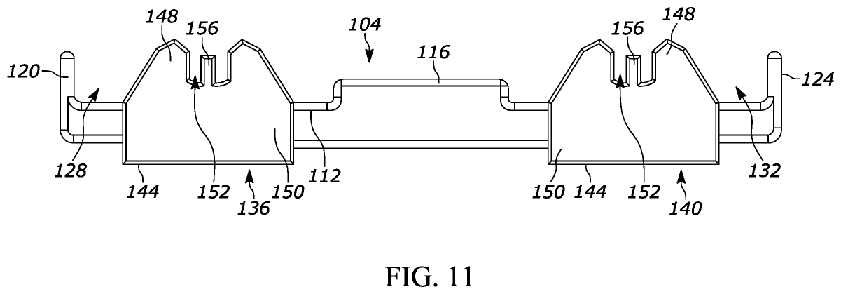

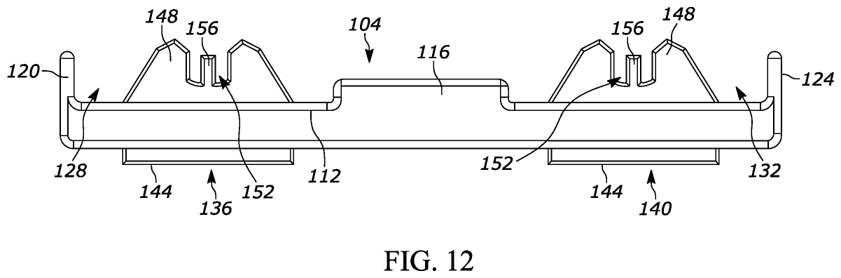

As shown in FIGS. 7 to 13, a first bushing 136 may be disposed within the first compartment 128 and a second bushing 140 may be disposed within the second compartment 132. The first bushing 136 and the second bushing 140 may be constructed from a rubber or synthetic rubber material (e.g., Santoprene®), although other deformable materials may also be used. The illustrated example includes the first and second bushings 136, 140 formed from the same material, although it is also possible to construct the second bushing 140 from a different material than the first bushing 136.

In some examples, the first and second bushings 136, 140 may be connected (e.g., removably or permanently) to the base portion 112. For example, the rubber or synthetic rubber material may be manufactured (e.g., overmolded, 3-D printed, etc.) separately from the base portion 112. As will be described in more detail below, the first and second bushings 136, 140 can slide onto the first section 104.

In other examples, the first and second bushings 136, 140 may be permanently connected to the base portion 112. For example, the rubber or synthetic rubber material may be overmolded onto the base portion 112, although other manufacturing processes, like 3-D printing, may be used. In this example, the first and second bushings 136, 140 may not be formed as separate elements prior to being connected to the base portion 112 (e.g., they are manufactured directly onto the base portion 112). Once the molding or other manufacturing process is complete, the first and second bushings 136, 140 may not be removable from the base portion 112.

As illustrated in FIGS. 10 to 13, each bushing 136, 140 may be connected to the first section 104 so that it is spaced apart from the central portion 116 and the respective projection 120, 124. For example, each bushing 136, 140 may be removably connected or overmolded to a center of the respective compartment 128, 132 so that each bushing 136, 140 is equally spaced from the central portion 116 and the respective projection 120, 124.

In the illustrated example, the first and second bushings 136, 140 may extend along the entire length of the respective compartment 128, 132. Although in other examples, the first bushing 136 and/or the second bushing 140 may only extend along a portion of the respective compartment 128, 132. For example, the first bushing 136 and/or the second bushing 140 may only be formed at one or both openings of the respective compartment 128, 132 at either end of the base portion 112. In other words, an alternate example may include a central portion of the first compartment 128 and/or a central portion of the second compartment 132 that does not include the overmolded material.

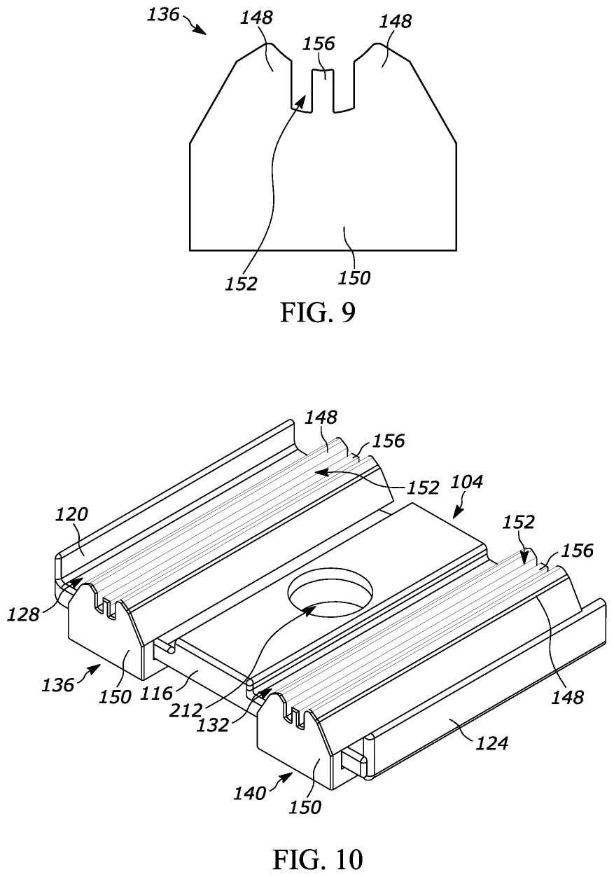

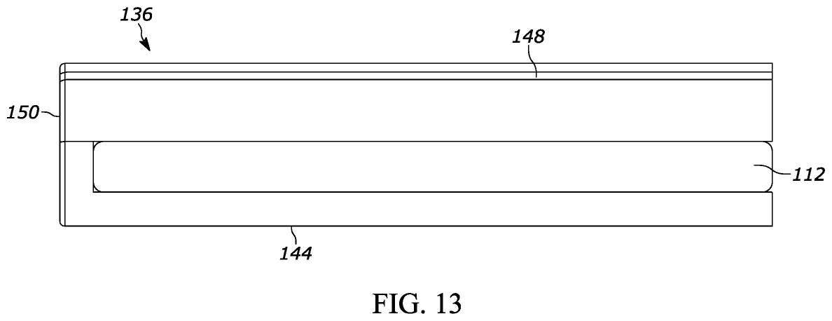

As shown in FIGS. 10 and 13, each of the first and second bushings 136, 140 may be connected on either side of the base portion 112. Viewed from the side (e.g., as shown in FIG. 13), each bushing 136, 140 may extend beyond an end of the base portion 112 (e.g., may be longer than the base portion 112). Viewed from an end (e.g., as shown in FIGS. 9 to 12), each bushing 136, 140 may be a generally trapezoidal shape on an end surface 150, although the end surface may have other shapes (e.g., triangular, rectangular, etc.). Each bushing 136, 140 may have a substantially planar surface 144, which may be substantially parallel to the surface of the base portion 112. In the illustrated example, each planar surface 144 may be disposed outside of the respective compartment 128, 132. One or more ends of each bushing 136, 140 may also have an end surface 150 that is planar. For example, each bushing 136, 140 in the illustrated example includes a planar surface 150 on one end (e.g., in a trapezoidal shape as described above). Other examples may include planar surfaces 150 on both ends.

Within each compartment 128, 132, the respective bushing 136, 140 may have a pair of spaced apart angled portions 148. As shown in FIGS. 7 and 9, a groove 152 may be formed between each pair of angled portions 148. In the illustrated example, the outer surface of each angled portion 148 may be inclined with respect to the surface of the base portion 112. An inner surface of each angled portion 148 may be substantially perpendicular with the surface of the base portion 112. The grooves 152 may therefore have a similar shape as the compartments 128, 132.

In some forms, each groove 152 may include a projection 156 that extends from a center of the groove 152. The projection 156 may be spaced apart from the angled portions 148. The projection 156 may also be thinner as compared to the angled portions 148.

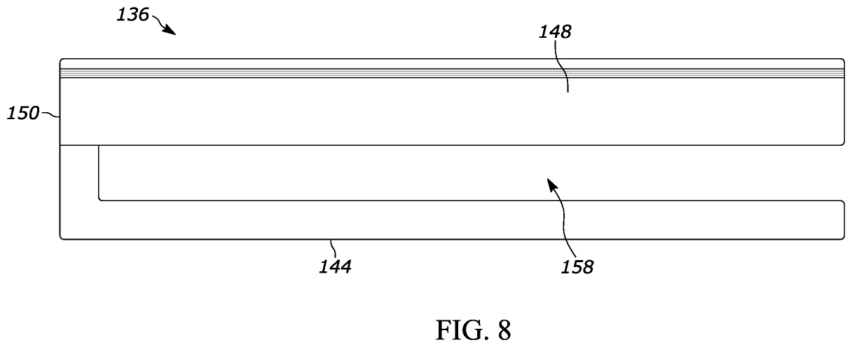

In some forms, each of the bushings 136, 140 may include a groove 158 that extends at least partially along the length of the respective bushing 136, 140. For example, FIG. 8 illustrates the groove 158 extending up to the end surface 150 but not passing through the end surface 150. The height of the groove 158 may be approximately the same as the height of the base portion 112.

After the bushings 136, 140 are manufactured, they may be slid into one of the compartments 128, 132 so that the groove 158 surrounds at least part of the base portion 112 within the respective compartment 128, 132. Each bushing 136, 140 may be connected to the base portion 112 via a frictional fit. In other examples, the bushings 136, 140 and the base portion 112 may be connected with a fastener (e.g., a mechanical fastener, a magnet, etc.). Either of these examples may allow the bushings 136, 140 to be removable. In other examples, the bushings 136, 140 may be permanently secured after being positioned within the respective compartment 128, 132 (e.g., by applying an adhesive).

In examples where the bushings 136, 140 are overmolded (or otherwise manufactured) directly to the base portion 112, the bushings 136, 140 may be formed around the base portion 112 so that the shape of each bushing 136, 140 is substantially the same as the example described above, but there is no distinct groove 158.

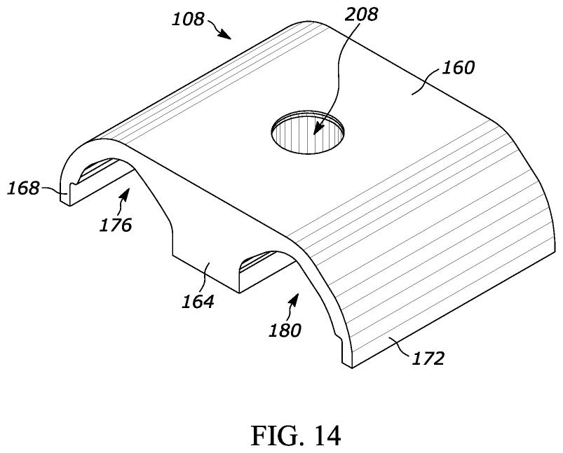

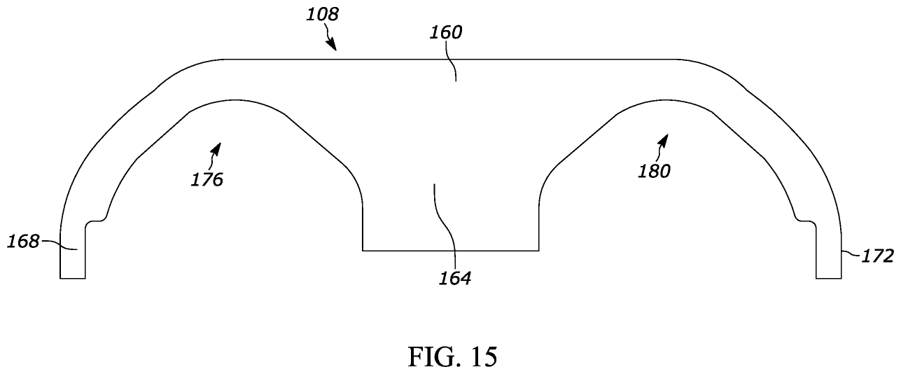

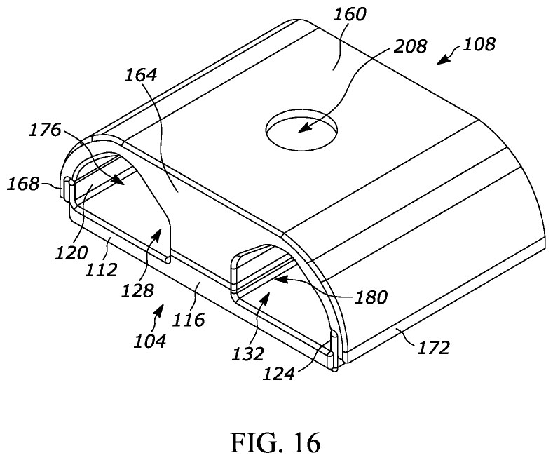

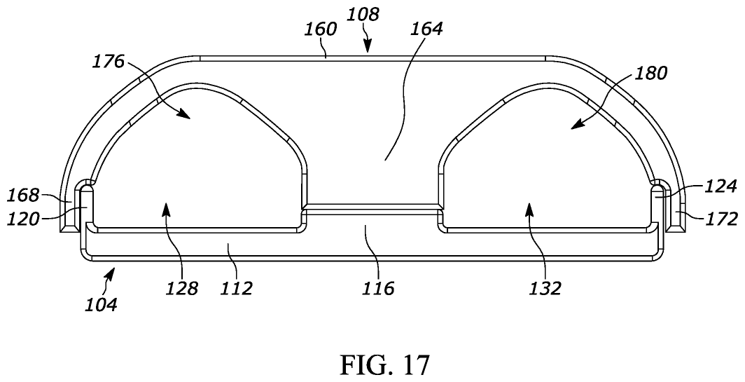

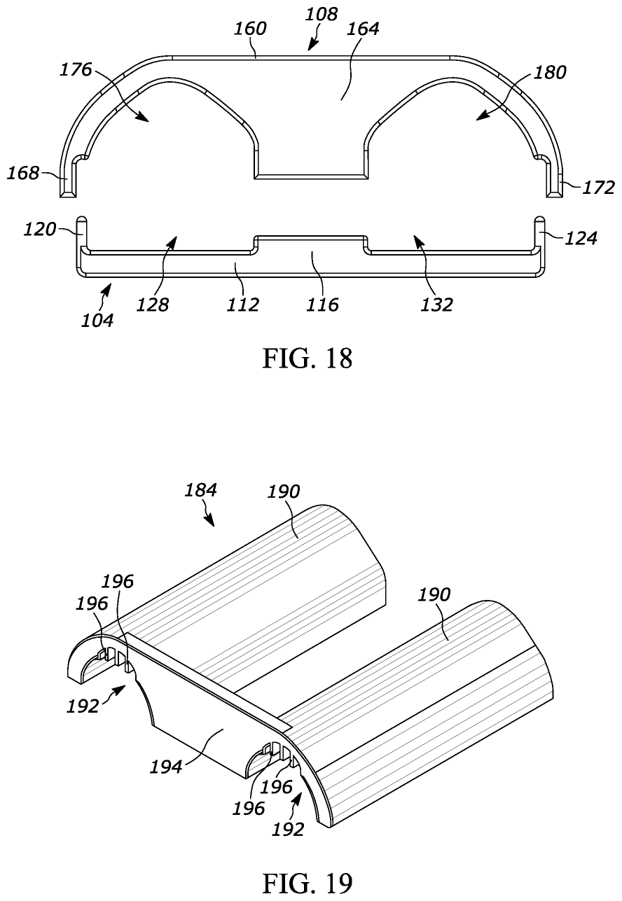

As shown in FIGS. 14 and 15, the second section 108 may be formed with an at least partially curved structure. However, other examples of the second section 108 may include a planar structure like the first section 104. The second section 108 may also be formed from a rigid material to maintain the curved shape (e.g., to limit deflection). The rigid material may be a metal, like aluminum, although other types of metals (e.g., steel, titanium, etc.) and/or other types of rigid materials (e.g., plastic) may be used to construct the second section 108. In the illustrated example, the first section 104 and the second section 108 are constructed from the same material, although in other examples they may be constructed from different materials.

With continued reference to FIGS. 14 and 15, the second section 108 may include a base portion 160 with a raised central portion 164. In the illustrated example, the central portion 164 may be formed approximately in the center of the base portion 160, although the central portion 164 may be offset from the center of the base portion 160. The illustrated central portion 164 is substantially perpendicular to the base portion 160, although other examples may include a central portion 164 that extends at a different angle with respect to the base portion 160.

In the illustrated example, the base portion 160 proximate to the central portion 164 of the second section 108 may be at least partially planar. The base portion 160 may project outwardly from this region with a curved orientation. The central portion 164 may be perpendicular to the planar portion of the base portion 160.

The second section 108 may also include a projection 168, 172 on either side of the base portion 160. Each projection 168, 172 may be spaced apart from the central portion 164. In the illustrated example, each projection 168, 172 may extend substantially perpendicularly from the base portion 160. Although in other examples, the first projection 168 and/or the second projection 172 may extend from the base portion 160 at a different angle. For example, alternate examples may include the first projection 168 and/or the second projection 172 extending at an angle between about 5° and about 175°. Alternate examples may include the first projection 168 and/or the second projection 172 extending at an angle between about 25° and about 155°. Alternate examples may include the first projection 168 and/or the second projection 172 extending at an angle between about 45° and about 135°. Alternate examples may include the first projection 168 and/or the second projection 172 extending at an angle between about 65° and about 115°.

As shown in FIG. 15, each projection 168, 172 may extend from the curved region of the base portion 160. Additionally, each projection 168, 172 may have a width that is less than the width of the base portion 160. Each projection may be disposed so that the outer surface of the respective projection 168, 172 is flush with the outer surface of the base portion 160. This may form a stepped region between the respective projection 168, 172 and an inner surface of the base portion 160.

The second section 108 also may include a first compartment 176 between the central portion 164 and the first projection 168, and a second compartment 180 between the central portion 164 and the second projection 172. As shown in FIGS. 14 and 15, each compartment 176, 180 may have a generally C-shape and may extend along the length of the second section 108. The first and second compartments 176, 180 may be substantially symmetrical, although as described above, either of the compartments 176, 180 may have a different shape than the other.

In the illustrated example, the second section 108 is formed as a unitary piece where the base portion 160, the central portion 164, and the projections 168, 172 are all formed together (e.g., in a mold). However, in other examples, the central portion 164 and/or at least one of the projections 168, 172 may be formed separately from the base portion 160.

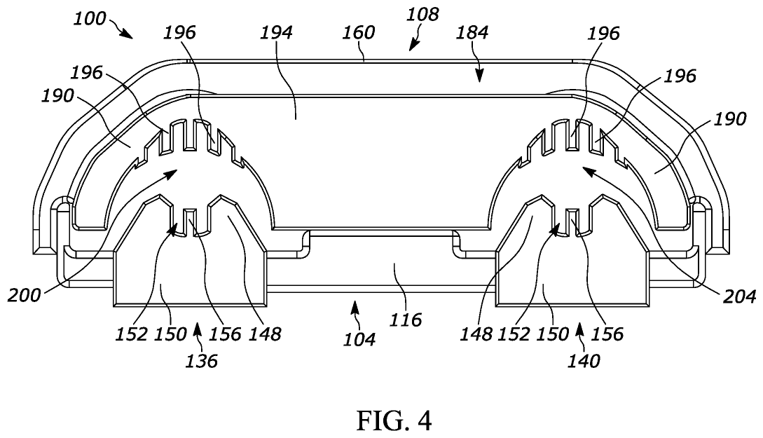

Returning to FIGS. 1 and 4, a bushing 184 may be disposed within the first compartment 176, within the second compartment 180, and across the central portion 164. For example, the second section 108 may include a single bushing 184, although in other examples, the second section 108 may include two bushings (e.g., one in each compartment 176, 180 where the central portion 164 may remain uncovered). The bushing 184 may be constructed from a rubber or synthetic rubber material (e.g., Santoprene®), although other deformable materials may also be used. The illustrated example includes the bushings 136, 140 from the first section 104 are constructed from the same material as the bushing 184 from the second section, although one or more bushings in either section 104, 108 may be constructed from a different material than the other bushings.

In some forms, the bushing 184 may be removably connected to the base portion 160. For example, the rubber or synthetic rubber material may be manufactured (e.g., molded, 3-D printed, etc.) separately from the base portion 160. Once the manufacturing process is complete, the bushing 184 may connect (e.g., with a press fit or friction fit) to the second section 108. Alternatively, a fastener (e.g., a mechanical fastener, a magnet, etc.) may be used to connect the bushing 184 to the second section 108. In either of these examples, the bushing 184 may be selectively removable from the second section 108. In alternate examples, the bushing 184 may be permanently connected to the second section 108 using an adhesive.

In other forms, the bushing 184 may be permanently connected to the base portion 160 by being formed against and/or around the base portion 160. For example, the rubber or synthetic rubber material may be overmolded onto the base portion 160, although other manufacturing processes, like 3-D printing, may be used. Once the molding or other manufacturing process is complete, the bushing 184 may not be removable from the base portion 160.

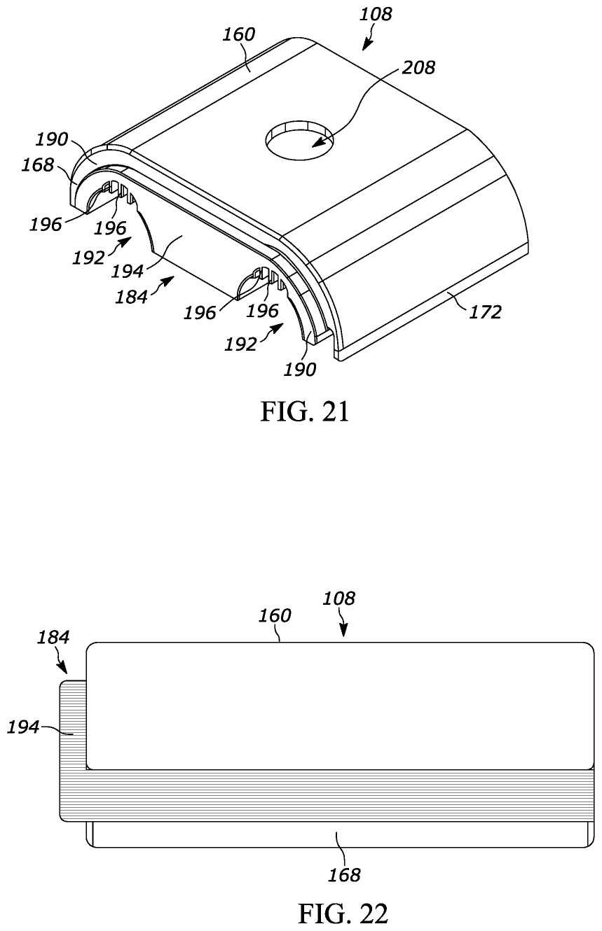

As illustrated in FIGS. 21 and 22, the bushing 184 may be coupled to the second portion 108 so that it covers substantially all of the inner surface of the base portion 160. The bushing 184 may be spaced apart from the projections 168, 172 because of the projections being spaced apart from the inner surface. However, the bushing 184 may extend past an end of the base portion 160 and at least partially along the length of at least one of the projections 168, 172.

In the illustrated example, the bushing 184 may extend along the entire length of both compartments 176, 180. For example, FIG. 22 illustrates that the bushing 184 extends the entire length of the compartments 176, 180. In addition, at least a portion of the bushing 184 extends outside of the compartments 176, 180. The bushing 184 may contact a surface of the central portion 164 on one side of the second portion 108 but not on the other side of the second portion 108. Although in other examples, the bushing 184 may only extend along a portion of one or both compartments 176, 180. For example, the bushing 184 may only be formed at one or both openings of one or both compartments 176, 180 at either end of the base portion 160. In other words, an alternate example may include a central portion of the first compartment 176 and/or a central portion of the second compartment 180 that does not include the material.

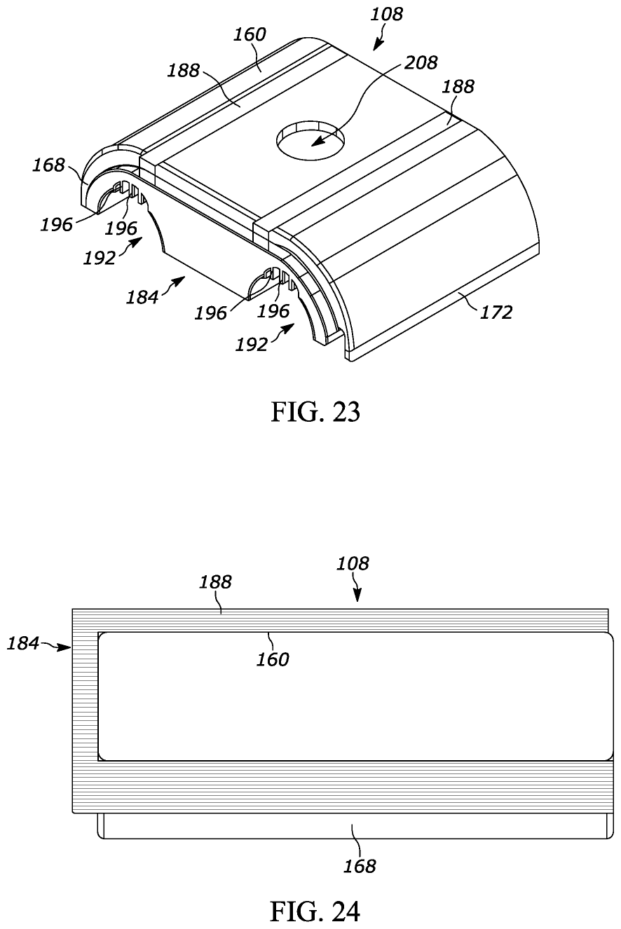

As shown in FIGS. 23 and 24, the bushing 184 may be coupled to either side of the base portion 160, although some examples may only include the bushing 184 on the inner surface (see e.g., FIGS. 21 and 22). Viewed from above (e.g., as shown in FIG. 23), the bushing 184 may extend beyond an end of the base portion 160 (e.g., may be longer than the base portion 160). The bushing 184 may substantially follow the shape of the base portion shown in FIG. 24. The bushing 184 may have a substantially planar surface 188, which may be substantially parallel to the surface of the base portion 160. In the illustrated example, the planar surface 188 may be disposed outside of the compartments 176, 180.

Within each compartment 176, 180, the bushing 184 may have a pair of side portions 190 that each form a groove 192. The side portions 190 may be connected to one another by a middle portion 194, although as described above, the side portions 190 may be formed separate from one another. Each side portion 190 may have a substantially C-shape or U-shape when viewed at an end, which may be a similar shape as the compartments 176, 180. In examples where the bushing 184 is formed separately from (e.g., not overmolded to) the base portion 160, the shape of the side portions 190 may allow the bushing 184 to connect to the base portion 160 (e.g., with a friction fit). In examples where the bushing 184 is manufactured directly to the base portion 160, the shape of the side portions 190 may be substantially the same as the shape of the compartments 176, 180 as a result of the manufacturing process.

The middle portion 194 may have a similar shape as the central portion 164 and may substantially cover the central portion 164.

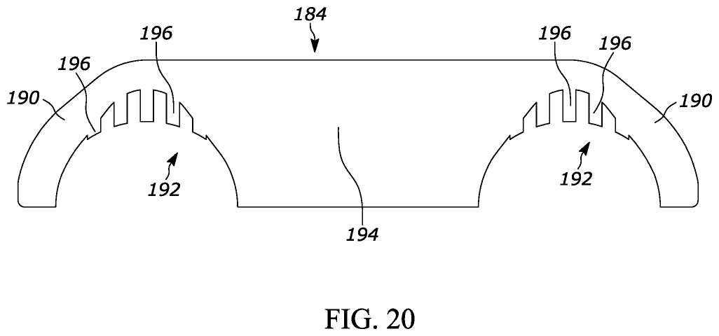

In some forms, each side portion 190 192 may include at least one projection 196 that extends from a center of the groove 192. As shown in FIGS. 19 and 20, the illustrated example includes five projections 196 in each groove 192, although any number of projections 196 may be used. Each projection 196 may be spaced apart from the other projections 196 in the same groove 192. The projections 196 may also be thinner as compared to the remainder of the bushing 184.

In use, the first and second sections 104, 108 may begin separated. In this position, the compartments 128, 132 of the first section 104 and the compartments 176, 180 of the second section 108 are not completely enclosed. A user may be able to position each of the sections 104, 108 around fiber optic cables. For example, the first section 104 may be positioned on one side of the cables while the second section 108 may be positioned on the other side of the cables. The user may then align the first and second sections 104, 108 to bring them into engagement.

As shown in FIGS. 1 and 4, the first section 104 and the second section 108 may be brought together to provide a clamp for cables. In the illustrated example, the first and second sections 104, 108 are aligned so that the first compartment 128 of the first section 104 and the first compartment 176 of the second section 108 form a first passageway 200, and the second compartment 132 of the first section 104 and the second compartment 180 of the second section 108 form a second passageway 204.

Additionally, the projections 120, 124 of the first section 104 may engage the projections 168, 172 of the second section 108. As described above, the bushing 184 may be spaced apart from each of the projections 168, 172 of the second section 108. When the first and second sections 104, 108 are engaged, the projections 120, 124 of the first section 104 may fit within the space between the bushing 184 and the respective projection 168, 172 of the second section 108 (see e.g., FIG. 4). In other words, each projection 168, 172 of the second section 108 may contact (or be positioned proximate to) an outer surface of the respective projection 120, 124 of the first section 104.

In some forms, the projections 120, 124 of the first section 104 may be received within the respective space in a loose engagement. This may facilitate disconnection of the first section 104 from the second section 108 to make realignments and/or repairs.

In other forms, inserting the projections 120, 124 into the space may engage and connect the first and second sections 104, 108 together. For example, the space between the bushing 184 and each projection 168, 172 of the second section 108 may be sufficiently small so that the respective projections 120, 124 create an engagement using a press fit or a frictional fit. In other examples, at least one of the projections 120, 124 on the first section 104 may include a first mechanical fastener (not shown) and the respective projection(s) 168, 172 on the second section 108 may include a second mechanical fastener (not shown) that is complementary to the first mechanical fastener. Engagement between the first and second mechanical fasteners may create a snap fit that removably connects the first and second sections 104, 108 together. In still other examples, at least one of the projections 120, 124 on the first section 104 may include a first magnet (not shown) and the respective projection(s) 168, 172 on the second section 108 may include a second magnet (not shown) that has an opposite polarity to the first magnet. In still another example, any two or more of the connection mechanisms may be combined for use when connecting the first and second sections 104, 108 together.

In the engaged position, the central portion 116 of the first section 104 and the central portion 164 of the second section 108 may be aligned with one another. More specifically, the bushing 184 of the second section 108 may contact the central portion 116 of the first section 104. This may partition the first and second passageways 200, 204 from one another (e.g., which may limit movement of the cables within the clamp 100). Additionally, contact between the bushing 184 and the central portion 116 may limit metal on metal contact. In other examples, the central portion 116 of the first section 104 may also be covered with rubber (or a similar material) to reduce exposed metal surfaces.

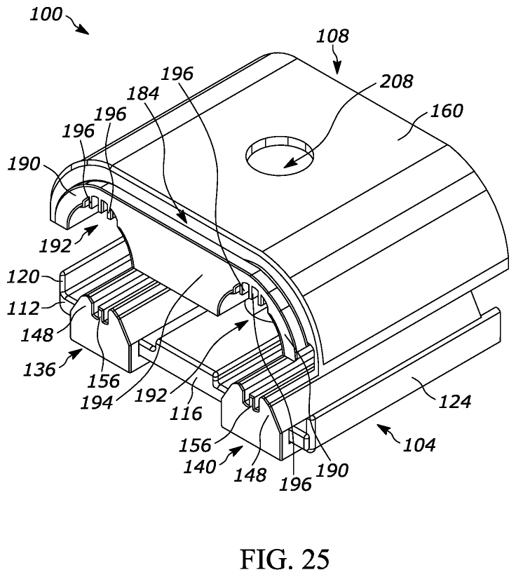

As shown in FIGS. 25 to 27, the clamp 100 is connected to a pair of cables 500 each having a first diameter. The first diameter of the cable 500 may be smaller in size compared to the width of the groove 152.

As shown in FIG. 25, the first section 104 may be positioned so that each cable 500 can received within one of the compartments 128, 132. More specifically, each cable 500 may be positioned within one of the grooves 152 of the respective bushings 136, 140. As described above, each cable 500 may be approximately the same size as the distance between the angled portions 148. However, the cable 500 may be larger than the space between one of the angled portions 148 and the projection 156. When positioning the cable 500 within the groove 152, the projection 156 may support a center of the cable 500. For example, the projection 156 may not buckle under the weight of the cable 500. The projection 156 assist in maintaining the position of the cable 500 relative to the angled portions 148. For example, the angled portions 148 may contact and support an outer surface of the cable 500.

In some forms, the cables 500 may have a small cross-sectional area and may be ordinarily prone to bending or pinching, which disrupt signals passing through the cables 500. The shape and/or size of the angled portions 148 may allow the cable 500 to be securely positioned (e.g., embedded) in order to limit deformations that cause signal disruptions.

A force may not be initially applied when the cables 500 are first placed in the respective grooves 152. For example, the cables 500 may be seated against the bushings 136, 140 without a force being applied toward the bushings 136, 140. In other words, the cables 500 may just rest on top of the bushings 136, 140 while the angled portions 148 are in their neutral position. In other examples, a user may apply a force to the cables 500 and/or the bushings 136, 140 so that the angled portions 148 move radially outward to accommodate the respective cable 148.

In some forms, the projection 156 may be able to compress without buckling. As described in more detail below, this can assist in allowing the angled portions 148 to contact the outer surface of the cable 500 without the cable 500 being seated too far within the groove 152. However, in other examples, the projection 156 may buckle in order to accommodate larger cables 500.

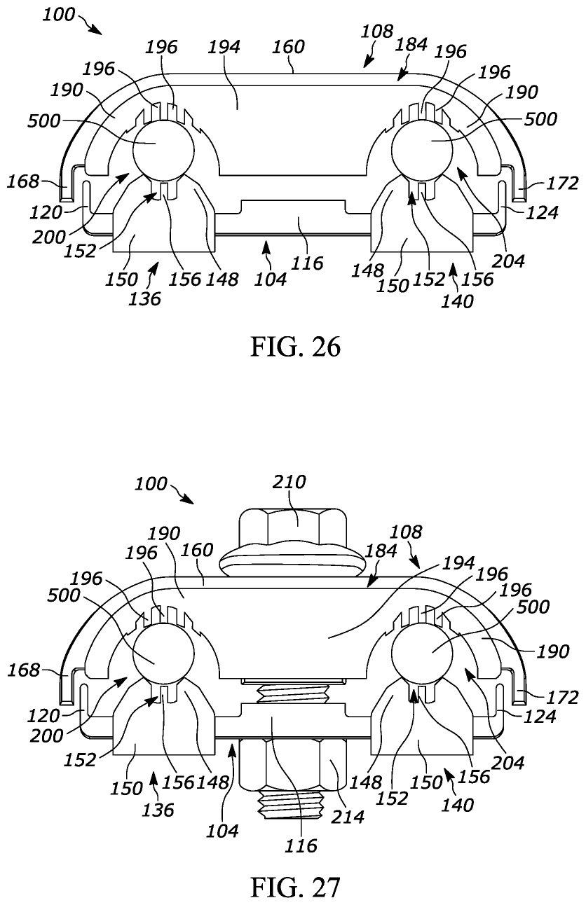

As shown in FIG. 26, once the cables 500 are positioned within the grooves 152, the second section 108 may be connected to the first section 108. As described above, the first and second sections 104, 108 are aligned so that the projections 120, 124 can engage the projections 168, 172. In this position, the cables 500 are partially enclosed by the formation of the first and second passageways 200, 204.

In addition, the bushing 184 may be brought into contact with the cables 500. As with the bushings 136, 140 of the first section 104, the bushing 184 of the second section includes projections 196, which are similarly flexible. The cables 500 may have a larger diameter than the distance between adjacent projections 196. As the second section 108 is brought into engagement, the cable 500 is forced between at least two of the projections 196. The projections 196 flex and/or compress to accommodate the diameter of the cable 500. The projections 196 may also be biased back toward an initial position to provide a securing force to the cable 500.

As illustrated in FIG. 26, the diameter of each cable 500 may be approximately equal to the distance between the projection 156 and the projections 196. The projections 156, 196 may not substantially compress or flex as a result of the second section 108 being moved into contact with the first section 104.

As shown in FIG. 27, once the first and second sections 104, 108 are connected together, a fastener 210 (e.g., a bolt) may be positioned through an opening 208 in the base portion 160. The opening 208 may also pass through the central portion 164. The base portion 112 may also include a similar opening 212 that is aligned with the opening 208 that also receives the fastener 210. The fastener 210 may be tightened (e.g., using a nut 214) after being inserted through both openings 208, 212 to provide a clamping force for the clamp 100. As the tightening of the fastener 210 occurs, the bushings 136, 140, 184 may compress around the cables 500. For example, the projections 156, 196 may compress as the distance between the first and second sections 104, 108 decrease. The compression may limit the squeezing or crimping of the cables 500 while within the clamp 100, which as mentioned above may negatively affect communication.

The cables 500 may become embedded within one or more of the bushings 136, 140, 184 as the fastener 210 is tightened in order to limit bending or pinching in the cable 500.

Additionally, as the fastener 210 is tightened, the rigid material of the first and second sections 104, 108 may experience limited deflection. In other words, the shape of the first and second sections 104, 108 does not substantially change while tightening occurs.

In some forms, the central portion 160 of the second section 108 may be in contact with or proximate to the central portion 116 of the first section 104 when the fastener 210 is fully tightened.

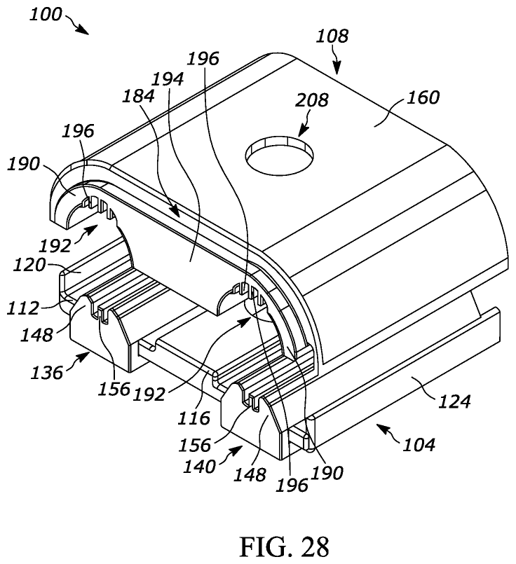

As shown in FIGS. 28 to 30, the clamp 100 is connected to a pair of cables 600 each having a second diameter, which is larger than the first diameter. The second diameter of the cable 600 may be greater in size than the width of the groove 152.

As shown in FIG. 28, the first section 104 may be positioned so that each cable 600 is received within one of the compartments 128, 132. More specifically, each cable 600 may be positioned within one of the grooves 152 of the respective bushings 136, 140. As described above, each cable 600 may be larger than the distance between the angled portion 148 and the projection 156. Each cable 600 may also be larger than the distance between the angled portions 148. When positioning the cable 600 within the groove 152, the angled portions 148 may flex to provide sufficient space for the cable 600. As described above, the bushings 136, 140 may be disposed in a central portion of the respective compartment 128, 132 and disposed away from the central portion 116 and the projections 120, 124. The angled portions 148 may be able to move because of the larger cable 600 without contacting the central portion 116 or the projections 120, 124. In other words, the central portion 116 and the projections 120, 124 may not act as stops for limiting the movement of the angled portions 148. After insertion, the angled portions 148 may be biased toward their original position and provide a securing force to the cable 600. Insertion of the cables 600 may also compress the projection 156 in order to create a wider area to receive the cable 600.

In other examples, each cable 600 may initially rest on top of the respective bushing 136, 140. In other words, the user may not initially apply a force to move the angled portions 148 to accommodate the respective cables 600. The angled portions 148 may not move until the second section 108 is connected as described below.

In some forms, the cables 600 may have a large cross-sectional area (e.g., as compared to the cable 500) and may be less prone to bending or pinching, and therefore less likely to have issues with signal transfers through the cables 600.

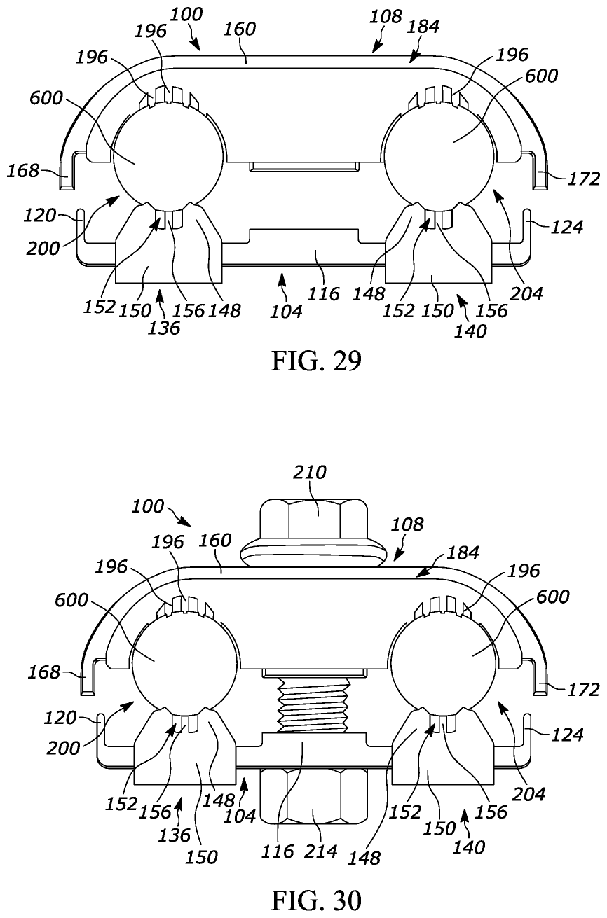

As shown in FIG. 29, once the cables 600 are positioned within the grooves 152, the second section 108 may be connected to the first section 108. As described above, the first and second sections 104, 108 are aligned so that the projections 120, 124 can engage the projections 168, 172. In this position, the cables 600 are partially enclosed by the formation of the first and second passageways 200, 204.

In addition, the bushing 184 may be brought into contact with the cables 600. As with the bushings 136, 140 of the first section 104, the bushing 184 of the second section includes projections 196, which are similarly flexible. The cables 600 may have a larger diameter than the distance between adjacent projections 196. As the second section 108 is brought into engagement, the cable 600 is forced between at least two of the projections 196. The projections 196 flex and/or compress to accommodate the diameter of the cable 600. The projections 196 may also be biased back toward an initial position to provide a securing force to the cable 600.

As illustrated in FIG. 29, the diameter of each cable 600 may be greater than the distance between the projection 156 and the projections 196. The projections 156, 196 may at least partially compress or flex as a result of the second section 108 being moved into contact with the first section 104. Alternatively, or in addition, the first and second sections 104, 108 may be spaced further apart as a result of the larger diameter of the cables 600.

In the illustrated example, the bushing 184 includes multiple projections 196 so that it can accommodate both a cable 500 with a smaller diameter and a cable 600 with a larger diameter. In other words, different projections 196 may be compressed when clamping different sized cables, although the cable may still be positioned between at least two of the projections 196.

As shown in FIG. 30, once the first and second sections 104, 108 are connected together, a fastener 210 (e.g., a bolt) may be positioned through an opening 208 in the base portion 160. The opening 208 may also pass through the central portion 164. The base portion 112 may also include a similar opening 212 that is aligned with the opening 208 and also receives the fastener 210. The fastener 210 may be tightened (e.g., using a nut 214) after being inserted through both openings 208, 212 to provide a clamping force for the clamp 100. As the tightening of the fastener 210 occurs, the bushings 136, 140, 184 may compress around the cables 600. For example, the projections 156, 196 may compress as the distance between the first and second sections 104, 108 decrease. The compression may limit the squeezing or crimping of the cables 600 while within the clamp 100, which as mentioned above may negatively affect communication.

In some forms, because the larger diameters of the cables 600 may not fit to be embedded within the bushings 136, 140, the deformation of the projections 196 as a result of tightening the fastener 210 may assist in maintaining the position of the cables 600 within the first and second sections 104, 108.

Additionally, as the fastener 210 is tightened, the rigid material of the first and second sections 104, 108 may experience limited deflection. In other words, the shape of the first and second sections 104, 108 does not substantially change while tightening occurs.

In some forms, the first section 104 and the second section 108 may be spaced further apart when the fastener 210 is fully tightened when the larger cable 600 is used as compared to when the smaller cable 500 is used.

As described above, the shape of the bushings 136, 140, 184 therefore assist in maintaining the position of cables of multiple sizes. This allows the same clamp 100 to be used with a variety of cables without having to replace the bushings 136, 140, 184, or other parts of the clamp 100.

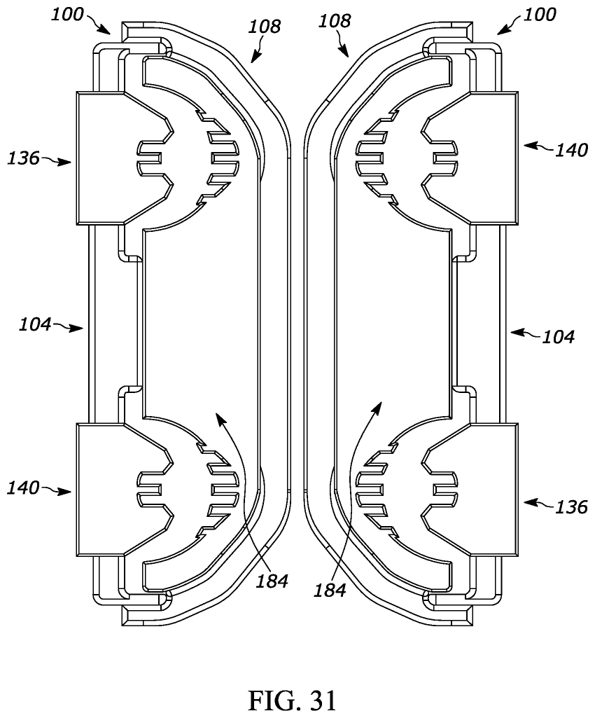

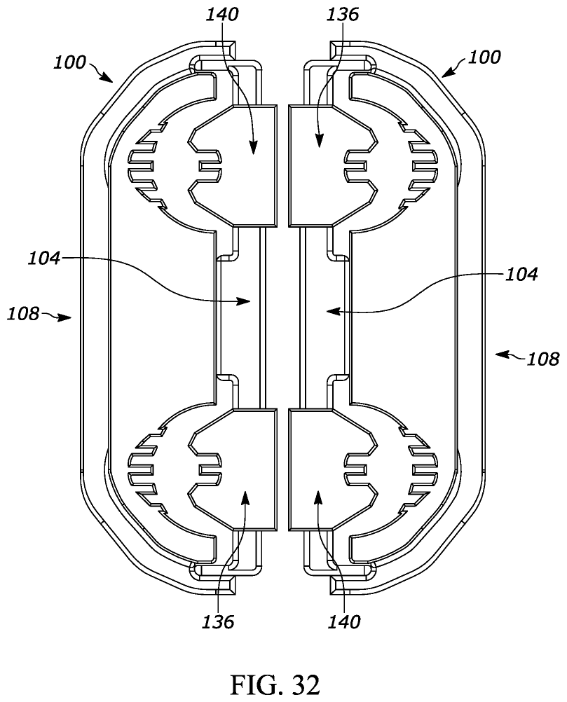

As shown in FIGS. 31 and 32, multiple clamps 100 may be used together to connect multiple pair of cables. The individual clamps 100 may be stacked on top of one another and secured together (e.g., by a single fastener extending through all the clamps 100). The clamps 100 may be stacked in any orientation. For example, the first section 104 of one clamp 100 may contact (or be positioned proximate to) the first section 104 of the other clamp 100 (see e.g., FIG. 31). Alternatively, the first section 104 of one clamp 100 may contact (or be positioned proximate to) the second section 108 of the other clamp 100 (see e.g., FIG. 32).

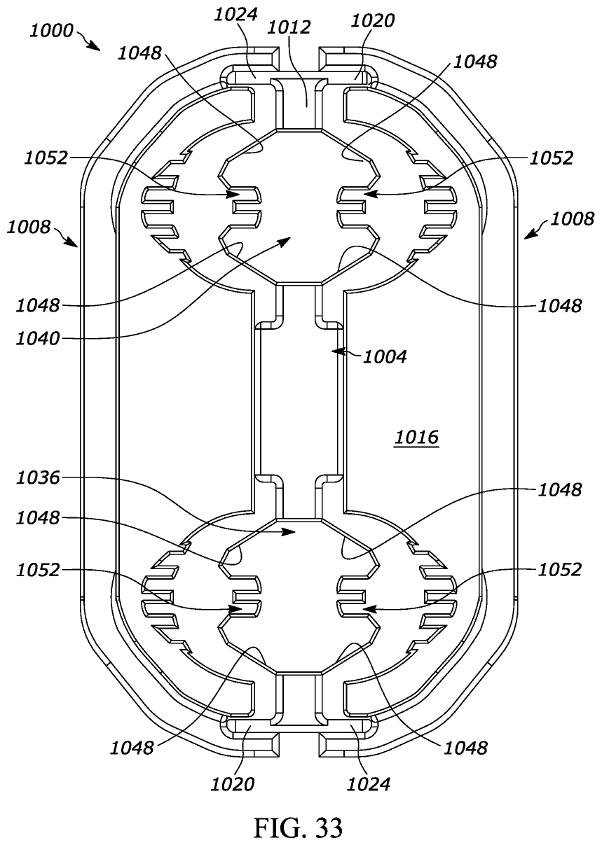

As shown in FIG. 33, an alternate example of a clamp 1000 may be able to connect to more than two cables. For example, the illustrated clamp 1000 is connected to four total cables. The clamp 1000 is like the clamp 100 and only some similarities and differences are described below. Similar elements are labeled with the same reference number plus “1000”.

The clamp 1000 may include two section sections 1008 that may be substantially similar to the second section 108 of clamp 100. The clamp 1000 may also include a first section 1004 that is symmetrical about two axes. For example, the first section 1004 may be symmetrical through the central portion 1016 like the first section 104. However, the first section 1004 may also be symmetrical along the perpendicular direction that extends along the length of the base portion 1012.

In this example, the first section 1004 may include a pair of central portions 1016 extending in opposite directions. Additionally, the first section may include projections extending in two directions from the base portion 1012. In some forms, the first section 1004 may include two projections 1020, 1024, where a middle of each projection is connected to the base portion 1012 so that each projection 1020, 1024 extends on both sides of the base portion 1012. In other forms, the first section 1012 may include four projections, with each projection extending in only one direction from the base portion 1012.

In this example, the bushings 1036, 1040 may not include a planar surface (e.g., like planar surface 140). Instead, each bushing 1036, 1040 may include a pair of angular portions 1048 on either side of the base portion 1012. This may form four different grooves 1052 for a cable to be positioned in.

Although the example in FIG. 33 is shown as having four passageways, further alternate examples may have different numbers of passageways (e.g., 2, 3, 5, 6, etc.). For example, the base portion 1012 could be asymmetric and have a different number of passageways on each side. In an asymmetric example, the clamp may include different second sections.

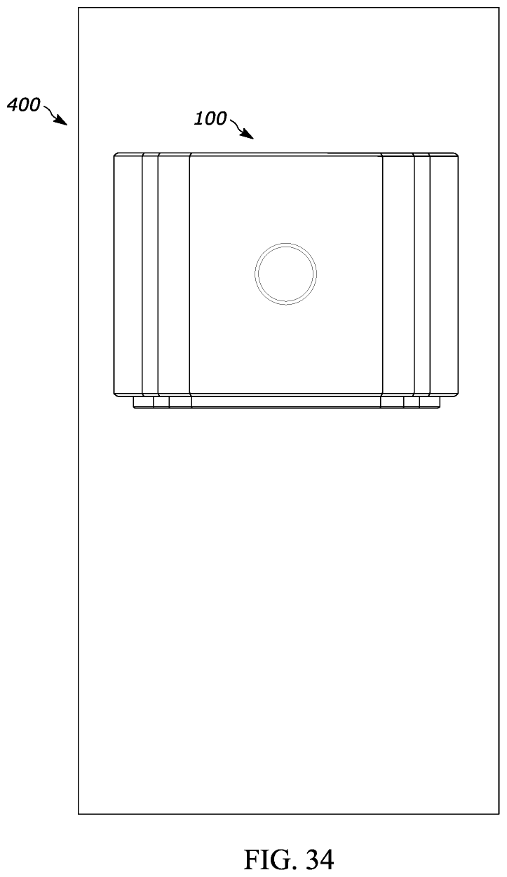

As shown in FIG. 34, the assembled clamp 100 may be connected to the support 400 to support the cables. For example, the bolt used to connect the first and second sections 104, 108 may also connect to the support. The flat surfaces on either the first section 104 (e.g., planar surface 144) or the second section 108 (e.g., planar surface 188) may be positioned against the support, which may form a flush engagement interface against a flat support. Contact between the bushings and the support may limit vibrational transfer and/or limit conduction.

One of ordinary skill will appreciate that the exact dimensions and materials are not critical to the disclosure and all suitable variations should be deemed to be within the scope of the disclosure if deemed suitable for carrying out the objects of the disclosure.

One of ordinary skill in the art will also readily appreciate that it is well within the ability of the ordinarily skilled artisan to modify one or more of the constituent parts for carrying out the various embodiments of the disclosure. Once armed with the present specification, routine experimentation is all that is needed to determine adjustments and modifications that will carry out the present disclosure.

The above embodiments are for illustrative purposes and are not intended to limit the scope of the disclosure or the adaptation of the features described herein to particular fiber optic cable clamps. Those skilled in the art will also appreciate that various adaptations and modifications of the above-described preferred embodiments can be configured without departing from the scope and spirit of the disclosure. Therefore, it is to be understood that, within the scope of the appended claims, the invention may be practiced other than as specifically described.

1. A clamp for securing a cable to a support, the clamp comprising:
a first section comprising,
a first base portion constructed from a first material,
a first bushing fixed to the first base portion and constructed from a second material that is more compressible than the first material, the first bushing including a first groove having at least one first projection, wherein the at least one first projection is configured to deform based on the size of the cable received within the first groove; and
a second section removable connected to the first section, the second section comprising,
a second base portion constructed from a third material,
a second bushing fixed to the second base portion and constructed from a fourth material that is more compressible than the third material, the second bushing including a second groove aligned with the first groove, the second groove having at least one second projection, wherein the at least one second projection is configured to deform based on the size of the cable received within the second groove.

2. The clamp of claim 1, wherein the first bushing is overmolded onto the first base portion, and wherein the second bushing is overmolded onto the second base portion.

3. The clamp of claim 1, wherein the first material and the third material are the same material, and wherein the second material and the fourth material are the same material.

4. The clamp of claim 1, wherein the first section further comprising a third bushing spaced apart from the first bushing and fixed to the first base portion, wherein the third bushing is constructed from a fifth material that is more compressible than the first material, and wherein the third bushing includes a third groove having at least one third projection, the at least one third projection is configured to deform based on the size of the cable received within the third groove.

5. The clamp of claim 4, wherein the second bushing further comprises a fourth groove aligned with the third groove and spaced apart from the second groove, the fourth groove having at least one fourth projection, wherein the at least one fourth projection is configured to deform based on the size of the cable received within the fourth groove.

6. The clamp of claim 4, wherein the first section includes a first central portion extending from the first base portion, and wherein the first central portion at least partially forms a first compartment and a second compartment.

7. The clamp of claim 6, wherein the second bushing contacts the first central portion when the second section is connected to the first section.

8. The clamp of claim 1, wherein the first bushing includes a pair of angled portions forming either side of the first groove, wherein the pair of angled portions are configured to move relative to one another when the cable is received within the first groove.

9. The clamp of claim 1, wherein the first section includes at least one first connecting projection extending from the first base portion and the second section includes at least one second connecting projection extending from the second base portion, wherein the at least one first connecting projection and the at least one second connecting projection are configured to engage when the first section is connected to the second section.

10. The clamp of claim 1, wherein the at least one first connecting projection engages the at least one second connecting projection with a snap fit, friction fit, press fit, and/or magnetic engagement.

11. A clamp for securing a cable to a support, the clamp comprising:
a first section comprising,
a first base portion constructed from a first material, the first base portion having a pair of first projections,
a first bushing fixed to the first base portion and spaced apart from either projection of the pair of first projections, the first bushing being constructed from a second material that is more compressible than the first material, the first bushing including a pair of spaced apart angular portions that form a groove, wherein the pair of angular portions is configured to deform based on the size of the cable received within the first groove; and
a second section removable connected to the first section, the second section comprising,
a second base portion constructed from a third material, the second base portion having a pair of second projections configured to engage with the pair of first projections,
a second bushing fixed to the second base portion and constructed from a fourth material that is more compressible than the third material, the second bushing including a second groove aligned with the first groove, wherein the second bushing is configured to deform based on the size of the cable received within the second groove.

12. The clamp of claim 11, wherein the first bushing is overmolded onto the first base portion, and wherein the second bushing is overmolded onto the second base portion.

13. The clamp of claim 11, wherein the first material and the third material are the same material, and wherein the second material and the fourth material are the same material.

14. The clamp of claim 11, wherein the first section further comprising a third bushing spaced apart from the first bushing and fixed to the first base portion, wherein the third bushing is constructed from a fifth material that is more compressible than the first material, and wherein the third bushing a pair of spaced apart angular portions that form a groove, wherein the pair of angular portions is configured to deform based on the size of the cable received within the third groove.

15. The clamp of claim 11, wherein the first pair of projections are configured to engage the second pair of projections with a snap fit, friction fit, press fit, and/or magnetic engagement.

16. A clamp for securing a pair of cables to a support, the clamp comprising:
a first section comprising,
a first base portion constructed from a first material,
a first bushing fixed to the first base portion and constructed from a second material that is more compressible than the first material, the first bushing including a first groove that is configured to deform based on the size of a first cable of the pair of cables received within the first groove, and
a second bushing fixed to the first base portion and constructed from a second material that is more compressible than the first material, the second bushing being spaced apart from the first bushing, the second bushing including a second groove that is configured to deform based on the size of a second cable of the pair of cables received within the second groove; and
a second section removable connected to the first section, the second section comprising,
a second base portion constructed from a third material,
a third bushing fixed to the second base portion and constructed from a fourth material that is more compressible than the third material, the third bushing including a third groove aligned with the first groove and a fourth groove aligned with the second groove, wherein the third groove and/or the fourth groove are configured to deform based on the size of the pair of cables.

17. The clamp of claim 16, wherein the first bushing and the second bushing are overmolded onto the first base portion, and wherein the third bushing is overmolded onto the second base portion.

18. The clamp of claim 16, wherein the first material and the third material are the same material, and wherein the second material and the fourth material are the same material.

19. The clamp of claim 16, wherein the first bushing includes a pair of angled portions forming either side of the first groove, wherein the pair of angled portions are configured to move relative to one another when the first cable is received within the first groove.

20. The clamp of claim 16, wherein the first groove includes at least one first projection, the at least one first projection is configured to deform based on the size of the first cable received within the first groove.

21.-30. (canceled)
